(19) United States
(12) Patent Application Publication
(10) Pub. No.: US 2014/0009422 A1
(43) Pub. Date: Jan. 9, 2014

(54) SCREEN CONTROL SYSTEM, SCREEN CONTROL DEVICE, AND INFORMATION PROCESSING TERMINAL

(71) Applicant: Kazuhisa ARIGAYA, Tokyo (JP)

(72) Inventor: Kazuhisa ARIGAYA, Tokyo (JP)

(21) Appl. No.: 13/936,456

(22) Filed: Jul. 8, 2013

(30) Foreign Application Priority Data
Jul. 9, 2012 (JP) 2012-153875
Feb. 13, 2013 (JP) 2013-025202
Apr. 11, 2013 (JP) 2013-082636

(51) Int. Cl. G09G 5/00

(52) U.S. Cl. CPC G09G 5/006
USPC 345/173; 345/1.2

(57) ABSTRACT

A screen control system includes: a plurality of information processing terminals; and a screen control device that makes the information processing terminals function as a screen display device to display a single screen. The screen control device includes a holding unit that holds display data to display using the information processing terminals, number of terminals constituting the screen, terminal identification information, and information indicative of layout positions of the respective information processing terminals in the screen; a generating unit that generates split display data obtained by dividing the display data in accordance with the number of terminals; and a split-display data transmitting unit that transmits the split display data. The information processing terminals each include: a transmitting unit that transmits the terminal identification information; a receiving unit that receives the split display data; and a display unit that displays the split display data.

### CROSS-REFERENCE TO RELATED APPLICATIONS

The present application claims priority to and incorporates by reference the entire contents of Japanese Patent Application No. 2012-153875 filed in Japan on Jul. 9, 2012, Japanese Patent Application No. 2013-025202 filed in Japan on Feb. 13, 2013 and Japanese Patent Application No. 2013-082636 filed in Japan on Apr. 11, 2013.

### BACKGROUND OF THE INVENTION

1. Field of the Invention

The present invention relates to a screen control system, a screen control device, and an information processing terminal.

2. Description of the Related Art

Electronic blackboards have been known that can read handwritten information, which is written on a writing surface of a whiteboard, a writing sheet, or the like using writing utensils, with a dedicated scanner and to output the information on a recording sheet with a dedicated printer.

Some electronic blackboard systems are available with a touch panel arranged on a writing surface of an electronic blackboard allowing handwritten information to be input in real time.

Furthermore, some electronic blackboard systems are available with a display device that includes a large screen for displaying characters and images and a touch input device with a touch panel arranged on the front face of the display device to constitute a display surface and a writing surface of the electronic blackboard thereof, respectively.

With such an electronic blackboard system, when material created on a personal computer (PC) is used at a meeting and such, the material can be shared with a large number of people by displaying it on a large screen (screen or display panel) such as a projector and a projection display without printing it on paper. Furthermore, the system allows not only the information to be displayed on the large screen, but also lines, characters, and the like to be handwritten on site where the characters and images are displayed, so that they can be combined as electronic data to be displayed or stored.

Such electronic blackboard systems are widely used in meetings, presentations, education, and others, and their usability is highly appreciated. However, the systems are basically configured on the assumption of being used at a specific fixed location such as a meeting room and a classroom.

Thus, all or a part of the devices constituting the electronic blackboard system, such as a display device, a touch input device, a controller implemented by a personal computer and such, and a printer are provided as separate devices. Consequently, the systems have some drawbacks such as being composed of a large number of devices, being expensive, requiring a wide setup space, and not being easy to move or set up.

Thus, Japanese Patent Application Laid-open No. 2000-043484, for example, describes a way to downsize and integrally combine the whole electronic blackboard system so as to improve its operability, handling, and convenience. More specifically, the electronic blackboard system disclosed in Japanese Patent Application Laid-open No. 2000-043484 is configured with a board unit composed of a display device of a plasma display panel and a touch input device that uses surface acoustic waves, a controller thereof, and a device housing unit that houses a computer, a printer, and others, all of which are integrated by a stand.

Furthermore, Japanese Patent Application Laid-open No. 2009-288453 describes that a plurality of small displays are joined together to configure a single larger display screen.

Even though the conventional electronic blackboard system is integrally combined with the board unit, the controller, and the device housing unit as described in Japanese Patent Application Laid-open No. 2000-043484, the system is still a considerably large dedicated system, and thus the system is yet expensive and is not necessarily easy to set up or move.

Furthermore, as described in Japanese Patent Application Laid-open No. 2009-288453, it is conceivable to join a plurality of small displays together to configure a single display screen as a screen of an electronic blackboard. In this case, however, it is necessary to measure the placement of display area of each display device with respect to a reference coordinate system by a position sensor and such, to acquire the shape of the corresponding one of the display areas, and then to estimate the shape of an overall display area that a user intended, whereby a dedicated device such as a position sensor is required. These drawbacks constitute a part of the reasons why the electronic blackboard systems have not yet widely used.

In view of the above, there is a need to provide a screen control system that can be readily used anywhere, and that can be set up or moved easily.

### SUMMARY OF THE INVENTION

It is an object of the present invention to at least partially solve the problems in the conventional technology.

A screen control system includes: a plurality of information processing terminals; and a screen control device that makes the information processing terminals function as a screen display device to display a single screen. The screen control device includes: a holding unit that holds display data to display using the information processing terminals, number of terminals indicative of number of information processing terminals constituting the screen, terminal identification information that identifies each of the information processing terminals, and information indicative of a layout position of each of the information processing terminals in the screen; a generating unit that generates split display data obtained by dividing the display data in accordance with the number of terminals; and a split-display data transmitting unit that transmits each piece of the split display data corresponding to corresponding one of the layout positions to corresponding one of the information processing terminals. The information processing terminals each include: a transmitting unit that transmits the terminal identification information of the corresponding information processing terminal to the screen control device; a receiving unit that receives the split display data transmitted from the screen control device; and a display unit that displays the split display data received by the receiving unit.

A screen control device makes a plurality of information processing terminals function as a screen display device to display a single screen. The screen control device includes: a holding unit that holds display data to display using the information processing terminals, number of terminals indicative of number of information processing terminals constituting the screen, terminal identification information that identifies each of the information processing terminals, and information indicative of a layout position of each of the information processing terminals in the screen; a generating unit that generates split display data obtained by dividing the display data in accordance with the number of terminals; and a split-display data transmitting unit that transmits each piece of the split display data corresponding to corresponding one of the layout positions to corresponding one of the information processing terminals.

An information processing terminal is capable of performing communication with a screen control device and serves as a screen display device that displays a single screen together with one or more information processing terminals. The information processing terminal includes: a transmitting unit that transmits own terminal identification information to the screen control device; a receiving unit that receives split display data transmitted from the screen control device; and a display unit that displays the split display data received by the receiving unit. The split display data is display data generated by dividing display data held by the screen control device in accordance with number of the information processing terminals.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram schematically illustrating a configuration of a screen control system according to an embodiment of the present invention;

FIGS. 2A and 2B are diagrams for explaining display examples on screens of the screen control system in the embodiment;

FIG. 3 is a block diagram illustrating an example of hardware configuration of a tablet PC that is one example of an information processing terminal constituting the screen;

FIG. 4 is a functional block diagram illustrating a functional configuration of respective units of the screen control system illustrated in FIG. 1;

FIGS. 5A and 5B are tables illustrating specific examples of screen management data;

FIG. 6 is a sequence diagram illustrating the exchange of data and instructions and a sequence of processes performed by a management terminal, a screen control server, and the tablet PC that is one example of the information processing terminal constituting the screen in the screen control system illustrated in FIG. 4;

FIG. 7 is a diagram illustrating an example of layout position information of the tablet PC that is one example of the information processing terminal constituting the screen;

FIG. 8 is a diagram illustrating another example of layout position information of the tablet PC that is one example of the information processing terminal constituting the screen;

FIG. 9 is a sequence diagram illustrating operations of respective units in the screen control server to output split display data;

FIG. 10 is a sequence diagram illustrating the operations of respective units in the screen control server to edit display data when a touch input is performed on the tablet PC that is one example of the information processing terminal;

FIG. 11 is a flowchart illustrating a sequence of operations performed by a management terminal 3 depicted in FIG. 4 when starting up a meeting;

FIG. 12 is a flowchart illustrating a sequence of operations performed by a screen control server 2 depicted in FIG. 4 when starting up the meeting;

FIG. 13 is a flowchart illustrating a sequence in a subroutine process of split-display data generation in FIG. 12;

FIG. 14 is a flowchart illustrating a sequence of operations performed by a tablet PC 10 depicted in FIG. 4 when starting up the meeting; and

FIG. 15 is a flowchart illustrating a sequence of operations performed by the screen control server 2 when a touch input is performed.

### DETAILED DESCRIPTION OF THE PREFERRED EMBODIMENT

An embodiment of the present invention will be specifically described based on the accompanying drawings hereinafter.

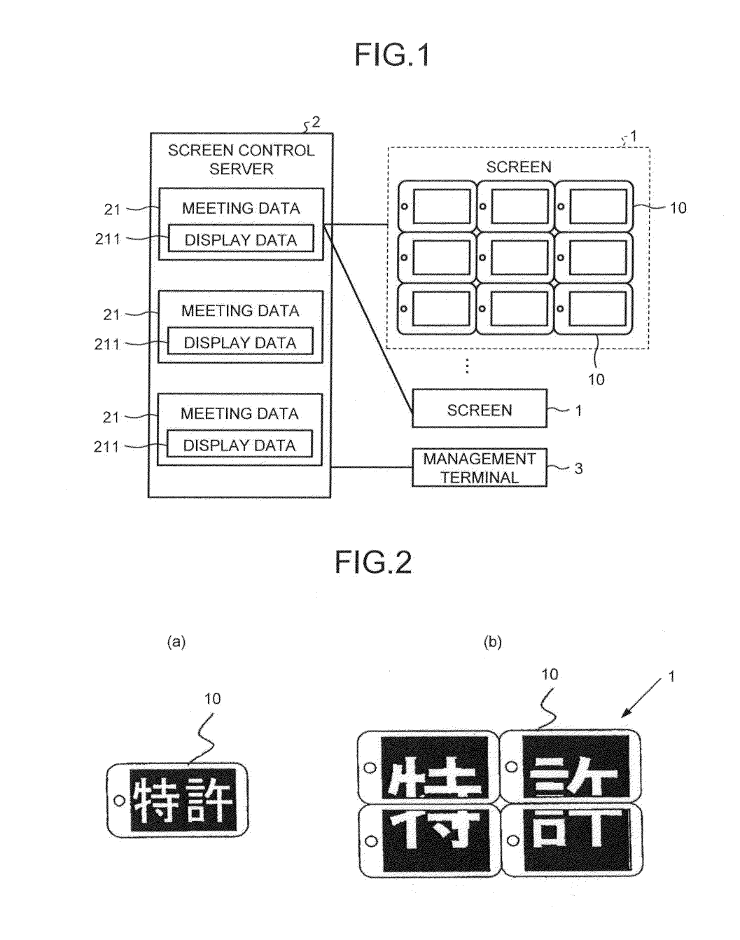

The general outline of one embodiment of a screen control system according to the invention will first be described with reference to FIGS. 1, 2A, and 2B. FIG. 1 is a block diagram schematically illustrating the configuration of the screen control system, and FIGS. 2A and 2B are diagrams for explaining display examples on the screens thereof.

The screen control system illustrated in FIG. 1 includes screens 1 composed of tablet PCs 10 that are examples of a plurality of information processing terminals, a screen control server 2 that controls the screens 1, and a management terminal 3.

The screen 1 serves as a screen display device that displays display data transmitted from the screen control server 2, which is a screen control device, on the tablet PCs 10 as a single screen. Furthermore, the display data can be appended in handwriting by performing touch input on any of the tablet PCs 10.

A plurality of screens 1 can be provided for a single meeting, and the number of tablet PCs 10 used for each of the screens 1 may be different from one another. The screens 1 may be remotely located as long as the screen 1 can be connected via a network to the screen control server 2. The term “meeting” used herein includes any situations in which the screen control system is used together with the tablet PCs 10, such as explanatory meeting, presentations, lectures, lecture meetings, shows, and business meetings.

When revision through handwriting is made by the touch input of a user on the screen 1, display data 211 for the meeting is revised and the revision is reflected on all of the screens 1 belonging to the same meeting.

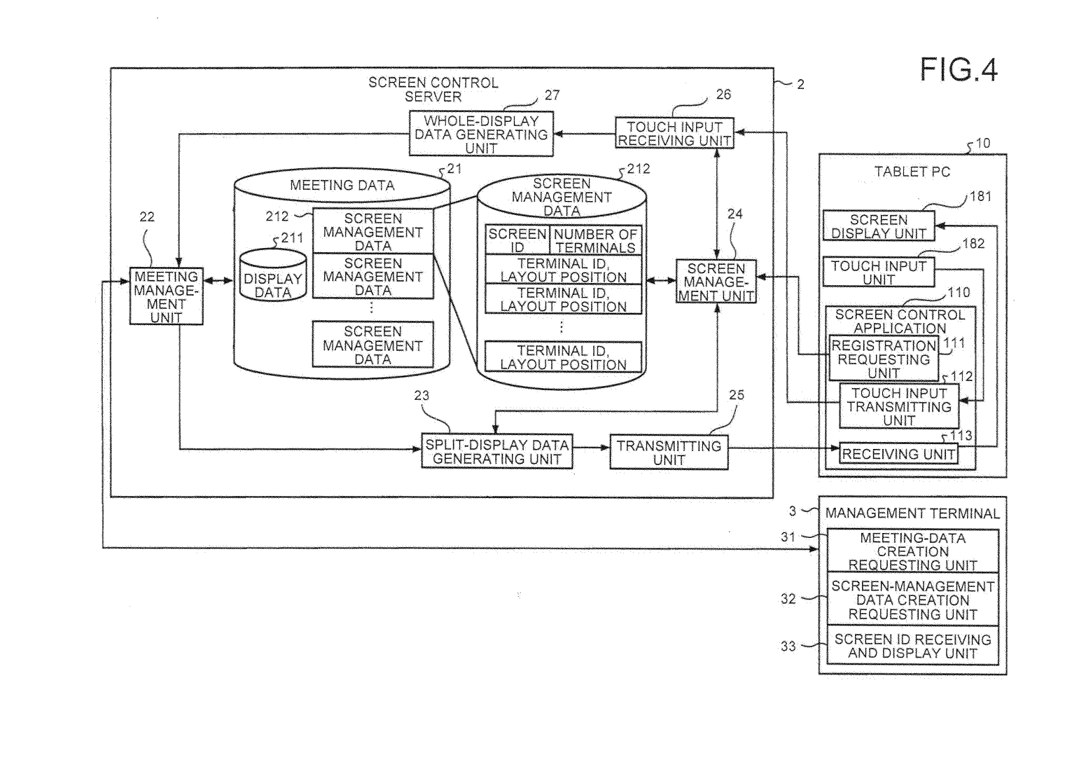

The screen control server 2 registers and retains therein a plurality of pieces of meeting data 21 to manage a plurality of meetings. Each piece of the meeting data (a lump to retain data for each meeting) 21 retains later described display data 211 used in a corresponding meeting, and one or more pieces of screen management data (illustrated in FIG. 4) to each manage one of the screens 1 belonging to the meeting in association with each other. While the screens 1 belonging to the same meeting data 21 normally display the same display data, in accordance with a process in the embodiment (described later), the display data in accordance with the layout positions of information processing terminals can be displayed. As for the screen control server 2, a general-purpose personal computer can be used by installing a screen-control server application (computer program).

The management terminal 3 transmits the display data 211 to the screen control server 2 and instructs the screen control server 2 to create the meeting data 21. The management terminal 3 further transmits the numbers of terminals constituting the screens 1 (the numbers of tablet PCs 10) and instructs the screen control server 2 to create the screen management data. The management terminal 3 can be achieved by installing a management terminal application on a general-purpose personal computer or one of the tablet PCs 10 constituting the screens 1. The management terminal 3 is provided for each of the screens 1.

The transmitting and receiving (communication) of data or signals between the screen control server 2 and each of the tablet PCs 10 constituting each of the screens 1 and between the screen control server 2 and the management terminal 3 are normally performed via a wireless LAN. The communication between each of the tablet PCs 10 constituting each of the screens 1 at a remote location and the screen control server 2 may be performed via a public telephone line or the Internet.

The screen control system of the present invention has the feature of combining a plurality (two or more) of information processing terminals including general-purpose tablet PCs and a variety of general-purpose tablet terminals such as smartphones and slate PCs to configure a single large screen that serves as a screen display device, so as to achieve a screen control system that can be used in a similar manner to an electronic blackboard.

For example, in the example illustrated in FIG. 2B, four tablet PCs 10 are arranged vertically and horizontally to form a single screen 1.

An image illustrated in FIG. 2A for a single tablet PC 10, i.e., an image of inverted black-and-white characters in this example is divided into four and is enlarged by doubling the horizontal and vertical size, and the divided images are displayed on the respective tablet PCs 10 constituting the screen 1 to display the enlarged inverted black-and-white characters as a whole as illustrated in FIG. 2B.

The table PC is an example of an information processing terminal and is a portable tablet personal computer that has a planar plate appearance and includes a touch screen in a panel form that serves as a screen display unit and also a touch input unit. The touch screens are often configured, in an overlapping manner, with a liquid crystal display panel or an organic EL display panel that displays characters, graphics, and others; and a touch input panel that allows information to be input or selected by lightly touching it with a finger. Some have a detachable keyboard as an input device. The tablet PC further has a wireless LAN function as a communication function.

Other devices than the tablet PCs such as smartphones can be used to configure the screen in the embodiment.

The tablet PCs 10 used to constitute the screen 1 preferably have the same display screen size. It is desirable to configure the screen with n² (n is an integer of two or greater) tablet PCs because the display screen of the tablet PC is generally in a rectangular shape. Consequently, orienting the display screens of the respective tablet PCs to be horizontally long and arranging each n tablet PCs in both the horizontal (right-left) and vertical (up-down) directions allows a landscape-oriented rectangular screen to be configured.

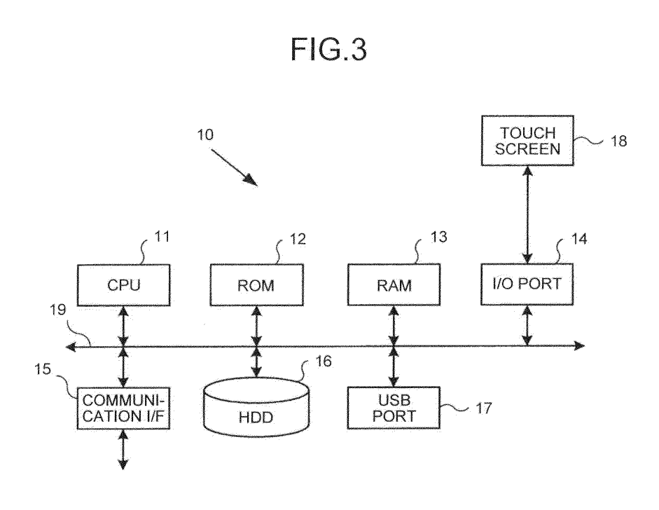

An example of hardware configuration of the tablet PC 10 will be briefly explained with reference to FIG. 3.

In the tablet PC 10, a CPU 11, a ROM 12, a RAM 13, and others are connected via a CPU bus 19 to allow data and signals to be exchanged with one another, and are configured as a microcomputer. The tablet PC 10 further includes a touch screen 18 connected to the CPU bus 19 via an I/O port 14.

The touch screen 18 is configured, as described previously, with a display of a liquid crystal display panel or an organic EL display panel, for example, and a touch input panel in an overlapping manner, and is a display-and-input device combined with a screen display unit and a touch input unit.

The tablet PC 10 further includes a communication interface (I/F) 15, a hard disk drive (HDD) 16 that is a mass storage device, and a USB port 17 to which a USB memory, a detachable keyboard, a pointing device or the like can be attached. Some tablet PCs 10 are mounted with a semiconductor memory of a large storage capacity in place of the HDD16.

Any one of the tablet PCs 10 having such a configuration and constituting the screen 1 can be also used as the management terminal 3 in FIG. 1. Alternatively, used may be a general-purpose personal computer that is configured similarly to the tablet PC 10 but includes a display for screen display and a keyboard for input separately in place of the touch screen 18.

A similarly configured general-purpose personal computer can be used as the screen control server 2 that is a screen control device.

With reference to the functional block diagram illustrated in FIG. 4, the functional configurations of the respective units in the screen control system illustrated in FIG. 1 will be described. In FIG. 4, only a single tablet PC 10 constituting the screen 1 in FIG. 1 is illustrated. However, in practice, each of the screens 1 used for each meeting is configured with a plurality of tablet PCs 10, and each of the tablet PCs 10 is connected to the screen control server 2 via a wireless LAN to allow communication. The functions of each of the tablet PCs 10 are the same, and thus only one of the tablet PCs 10 is illustrated as a representative.

The tablet PC 10 includes a screen display unit 181 and a touch input unit 182 of the touch screen 18 depicted in FIG. 3. The microcomputer composed of the CPU 11, the ROM 12, the RAM 13, and others depicted in FIG. 3 executes the process of a screen control application 110 to achieve respective functions so as to make the tablet PC 10 serve as a part of the screen 1 depicted in FIG. 1.

The screen control application 110 has the functions of a registration requesting unit 111, a touch input transmitting unit 112, and a receiving unit 113. The registration requesting unit 111 transmits a terminal ID, which is terminal identification information to identify the own tablet PC 10, to the screen control server 2 to make the screen control server 2 register the tablet PC 10 in the meeting data 21 as a constituent of the screen 1, and requests the own layout position in the screen 1. The touch input transmitting unit 112 transmits touch input data detected by the touch input unit 182 to the screen control server 2. The receiving unit 113 receives split display data transmitted from the screen control server 2 and makes the screen display unit 181 display the split display data.

In the embodiment, the registration requesting unit 111 further has the function of a transmitting unit to transmit the terminal ID, which is the terminal identification information to identify the own tablet PC, to the screen control server 2, and the function of requesting the screen control server 2 to register the tablet PC in screen management data 212 when transmitting the terminal ID. The receiving unit 113 serves as a receiving unit to receive split display data transmitted from the screen control server 2, and the screen display unit 181 serves as a display unit to display the received split display data. Furthermore, the touch input transmitting unit 112 has the function of a touch-input transmitting unit to transmit touch input data from the touch input unit 182 to the screen control server 2.

The management terminal 3 has the functions of a meeting-data creation requesting unit 31 that transmits display data to the screen control server 2 and requests the screen control server 2 to create meeting data, and a screen-management data creation requesting unit 32 that transmits the number of terminals (the number of tablet PCs 10) constituting a screen to the screen control server 2 and requests the screen control server 2 to create the screen management data 212. The management terminal 3 further has the function of a screen-ID receiving and display unit 33 that receives and displays a screen ID notified from the screen control server 2.

In the embodiment, the meeting-data creation requesting unit 31 serves as a transmitting unit that transmits display data to the screen control server 2, and the screen-management data creation requesting unit 32 serves as a unit that transmits the number of terminals constituting a screen to the screen control server 2. While not depicted in FIG. 4, the management terminal 3 further has a function, as described later, as a unit that transmits a notification indicating that the placement of all of the tablet PCs constituting the screen is completed to the screen control server 2.

When the number of screens used for a single meeting is only one, the screen ID to identify the screen is not necessary, and thus the screen-ID receiving and display unit 33 can be omitted.

These functions are achieved by at least one of the tablet PCs 10 constituting the screens 1 or a general-purpose personal computer executing the process of the management terminal application. When at least one of the tablet PCs 10 has these functions, the transmitting unit of the above-described registration requesting unit 111 in the tablet PC 10 is to further have the function of transmitting the display data, the number of terminals, and the notification indicating that the placement of all of the tablet PCs 10 constituting the screen 1 is completed to the screen control server 2.

Although one management terminal 3 is placed for each of positions each constituting one of the screens 1, when a plurality of screens 1 are used for a single meeting, only one of the management terminals 3 corresponding to the respective screens 1 needs to have the meeting-data creation requesting unit 31.

Furthermore, in a small-scale screen control system, when the screen control server 2 is placed in the same room as the screen 1 is placed, the screen control server 2 can have the same functions as those of the management terminal 3 to also serve as the management terminal 3, and thus the management terminal 3 can be omitted.

The screen control server 2 creates and manages one or more pieces of the meeting data 21 by a meeting management unit 22. The screen control server 2 can create a single piece of the meeting data 21 for each single meeting, and hold a plurality of pieces of the meeting data 21. Each piece of the meeting data 21 includes a single piece of the display data 211 and one or more pieces of the screen management data 212.

The screen management data 212 is composed of a screen ID, the number of terminals indicating the number of tablet PCs registered for a screen, terminal IDs that are identification information to identify the respective registered tablet PCs, and the data indicative of the layout position of each tablet PC in the screen, and is managed by a screen management unit 24.

The meeting data 21 can be held in the HDD 16 depicted in FIG. 3 or in a large-capacity memory that substitutes for the HDD 16.

In the embodiment, the meeting management unit 22 manages the display data 211 of the meeting data 21, and the screen management unit 24 manages the screen management data 212. This makes these units serve as a holding unit to hold the display data to display using a plurality of tablet PCs 10, the number of terminals indicative of the number of tablet PCs constituting the screen, the terminal ID that identifies each of the tablet PCs, and the information indicative of the layout position of each tablet PC in the screen.

When a terminal ID is received from the tablet PC 10, the screen control server 2 further functions to determine the layout position of the tablet PC 10 having the terminal ID in the screen, and to generate at least one piece of the screen management data 212 in which the terminal ID and the information indicative of the layout position in the screen are registered in association with each other.

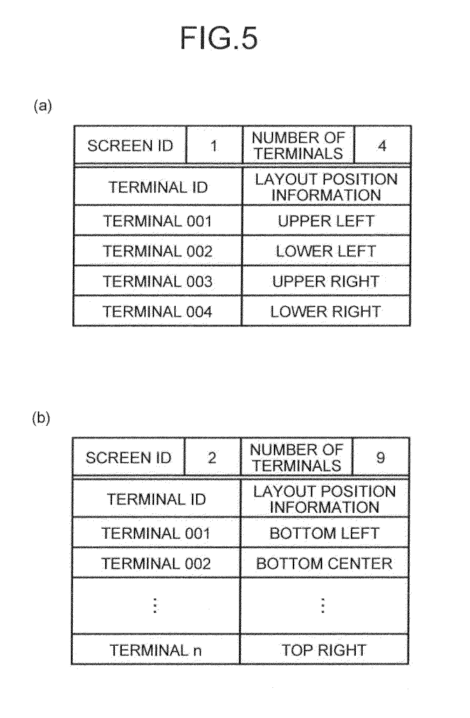

FIGS. 5A and 5B illustrate specific examples of the screen management data 212.

FIG. 5A illustrates an example in which a single screen is configured with four tablet PCs by arranging two tablet PCs each vertically and horizontally as illustrated in FIG. 2B. In this case, in a state in which the number of tablet PCs necessary to display is registered, the number of terminals is four, and the layout information is registered, indicating that the respective four terminals having terminal IDs different from one another are placed at four layout positions of upper-left, lower-left, upper-right, and lower-right.

FIG. 5B illustrates an example in which a single screen is configured with nine tablet PCs by arranging three tablet PCs each vertically and horizontally (see FIG. 8). In this case, in a state in which the number of tablet PCs necessary to display is registered, the number of terminals is nine, and the layout information is registered, indicating that the respective nine terminals having terminal IDs different from one another are placed at nine layout positions of bottom-left, bottom-center, . . . , and top-right.

The layout position may be indicated by identification information such as a number and a symbol. Furthermore, it is not necessary to make registration in the order illustrated in FIGS. 5A and 5B. The terminal IDs are not necessary to be sequential numbers because the terminal ID is the identification information of the terminal.

Other than the foregoing, the screen control server 2 further includes a split-display data generating unit 23 that generates split display data, a transmitting unit 25 that transmits the generated split display data to the respective tablet PCs 10, a touch input receiving unit 26 that receives touch input data transmitted from each of the tablet PCs 10, and a whole-display data generating unit 27 that generates display data of a whole image revised by the touch input data. The details of the foregoing will be described later with reference to sequence diagrams.

In the embodiment, the split-display data generating unit 23 is a generating unit that divides the display data of the whole image in accordance with the number of terminals and generates respective pieces of split display data, and the transmitting unit 25 is a split-display data transmitting unit that transmits the split display data corresponding to the layout positions to the respective tablet PCs 10.

Furthermore, the touch input receiving unit 26 is a touch-input receiving unit that receives touch input data when any one of the tablet PCs 10 transmits the touch input data, and the whole-display data generating unit 27 is a unit that revises the whole-image display data of the display data 211 based on the touch input data received by the touch input receiving unit 26 and rewrites the display data 211.

When the display data 211 is rewritten, the split-display data generating unit 23 divides the display data of the rewritten whole image and generates the respective pieces of split display data.

The functions of the respective units can also be achieved by a general-purpose personal computer executing the screen-control server application (computer program).

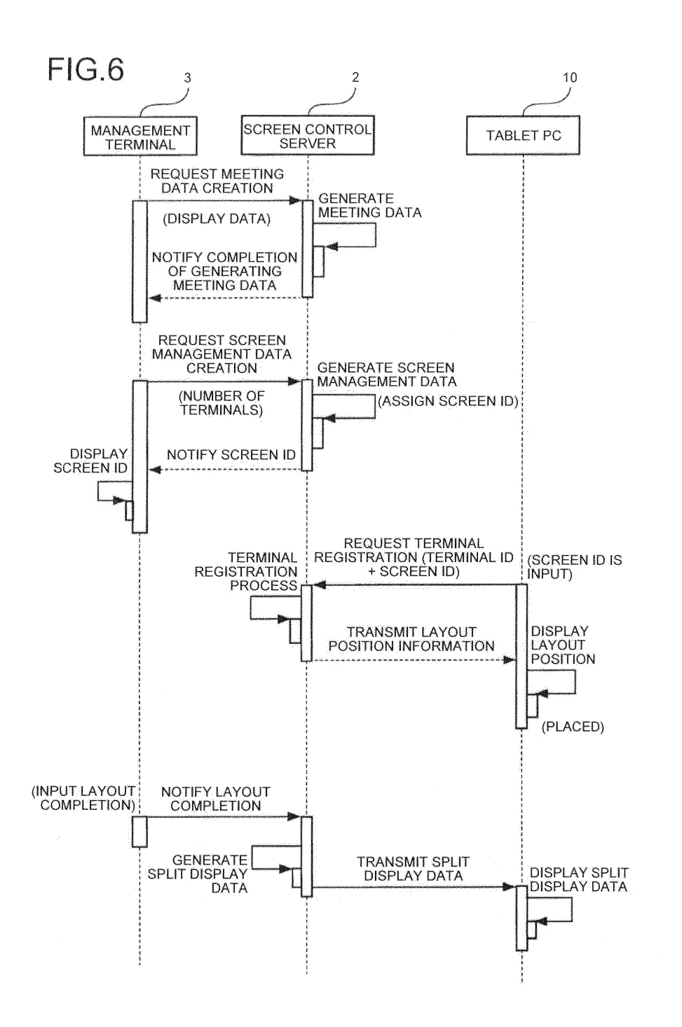

The exchange of data and instructions and the sequence of processes performed by the management terminal 3, the screen control server 2, and the tablet PC 10 constituting the screen 1 in the screen control system illustrated in FIG. 4 will be described with reference to a sequence diagram illustrated in FIG. 6.

The management terminal 3 first requests the screen control server 2 to create meeting data. At this time, the management terminal 3 transmits the display data of a whole image to the screen control server 2. At that time, it is preferable that the management terminal 3 further transmits data such as the name of a meeting, and the start and end time of the meeting scheduled.

When the screen control server 2 receives the request to create meeting data and the whole-image display data from the management terminal 3, the screen control server 2 assigns a name or an ID to the meeting, and generates the meeting data that holds display data concerning the meeting and screen management data. However, the screen control server 2 holds only the display data 211 at this point and the screen management data has no content yet. When the generation of meeting data is completed, the screen control server 2 notifies the management terminal 3 of the completion of generating the meeting data.

The management terminal 3 then requests the screen control server 2 to create the screen management data. At this time, the management terminal 3 notifies the screen control server 2 of the number of terminals constituting the screen 1 (the number of tablet PCs 10 constituting the screen 1). Upon receiving the number of terminals, the screen control server 2 generates the screen management data 212, assigns a screen ID that identifies the screen 1 to the screen management data 212, stores the received number of terminals in the screen management data 212, and notifies the management terminal 3 of the screen ID.

As a plurality of pieces of the screen management data 212 can be created for a single meeting to manage a plurality of the screens 1, the screen ID is required to identify each of the screens 1.

The screen ID may be assigned, for example, A01 is assigned to the first screen of a meeting A and A02 is assigned to the second screen thereof, and B01 is assigned to the first screen of a meeting B and B02 is assigned to the second screen thereof.

When the management terminal 3 is notified of a screen ID from the screen control server 2, the management terminal 3 receives the screen ID and displays it on a display unit (a display) of its own to let an administrator of the screen or a user of each of the tablet PCs 10 know the screen ID.

Consequently, the administrator of the screen notifies the screen ID to the user of each tablet PC 10, or the user of each tablet PC 10 knows the screen ID by directly looking at the display on the management terminal 3.

Subsequently, when the user of each tablet PC 10 inputs the screen ID to his/her tablet PC 10 in sequence to direct the tablet PC 10 to make a registration request to the screen control server 2, the tablet PC 10 adds the input screen ID to the terminal ID of its own and then transmits the information of the terminal ID and the screen ID to the screen control server 2 to request terminal registration.

When the screen control server 2 receives the information of the terminal ID and the screen ID, the screen control server 2 determines the layout position of the terminal identified by the terminal ID in the order of registration, and performs a terminal registration process in which the terminal ID and the layout position thereof are stored in association with each other in the screen management data 212 corresponding to the screen ID, as illustrated in FIG. 4. The screen control server 2 then transmits the information of the determined layout position to the tablet PC 10 of the terminal ID.

The screen management unit 24 in the holding unit of the screen control server 2 illustrated in FIG. 4 also has the function of determining the layout position, and the transmitting unit 25 that is the split-display data transmitting unit also has the function of transmitting the information indicative of the layout position to the tablet PC 10 having the terminal ID corresponding to the layout position.

The tablet PC 10 that received the information of layout position by the receiving unit 113 depicted in FIG. 4 displays the information on the screen display unit 181. The user of the tablet PC 10 or someone else reads the display and then places the tablet PC 10 to the layout position specified in the display.

The terminal registration process and the exchange and process concerning the layout position between the tablet PC 10 and the screen control server 2, and the manual placement of the tablet PCs 10 are performed in sequence until the registration and the placement of all of the tablet PCs 10 constituting the screen are completed.

When the placement of a given number of tablet PCs 10 is completed and the screen 1 as illustrated in FIG. 1 is completed, the administrator of the management terminal 3 checks for the completion of placement and inputs the layout completion to the management terminal 3. Consequently, the management terminal 3 notifies the screen control server 2 of the layout completion.

When the screen control server 2 receives the notice, the screen control server 2 generates the split display data from the display data of the whole image in accordance with the number of terminals constituting the screen, and transmits the respective pieces of split display data to the corresponding tablet PCs 10.

The tablet PCs 10 that received the split display data display the respective pieces of received split display data on the screen display unit 181 depicted in FIG. 4. This allows the whole screen illustrated in FIG. 1 to be displayed.

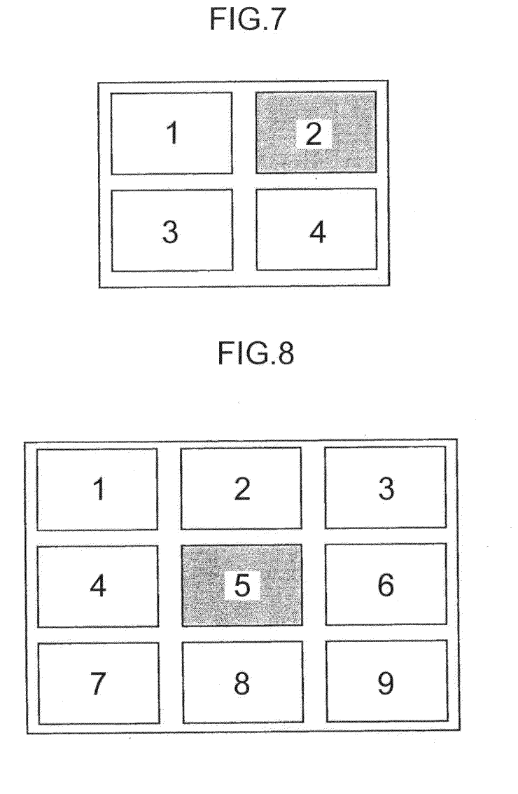

The above-described layout position information will now be described with the examples illustrated in FIGS. 7 and 8.

FIG. 7 is an example of layout position information when the screen is configured with four tablet PCs. In this example, the whole area of a rectangle representing a screen is divided by four, and each one-quarter area is defined as the layout position of the respective tablet PCs. Each one-quarter area is represented by a numerical value of 1 to 4 in the order of registration from upper left to lower right, and the position of the area for an appropriate tablet PC is indicated in color (halftone dots in FIG. 6). This example indicates the layout position 2 of the second-registered tablet PC.

FIG. 8 is an example of layout position information when the screen is configured with nine tablet PCs. In this example, the whole area of a rectangle representing a screen is divided by nine, and each one-ninth area is defined as the layout position of the respective tablet PCs. Each one-ninth area is represented by a numerical value of 1 to 9 in the order of registration from top left to bottom right, and the position of the area for an appropriate tablet PC is indicated in color (halftone dots in FIG. 7). This example indicates the layout position 5 of the fifth-registered tablet PC.

When the screen control server 2 receives the information of the terminal ID and the screen ID from the tablet PC 10 and performs the above-described terminal registration process, the screen control server 2 then generates an image indicative of layout position as illustrated in FIG. 7 or 8 in accordance with the layout position determined for the terminal ID, and transmits the image data thereof as the layout position information to the tablet PC 10 that transmitted the terminal ID.

The tablet PC 10 that received the layout position information displays the image by the layout position information as illustrated in FIG. 7 or 8 to let the administrator of the tablet PC 10 know the position thereof to be placed.

To make it easy to place the tablet PCs constituting the screen to the positions specified by the layout position information as illustrated in FIG. 7 or 8, a frame-like stand that is partitioned by the size of one tablet PC each may be set up at the location to set up the screen.

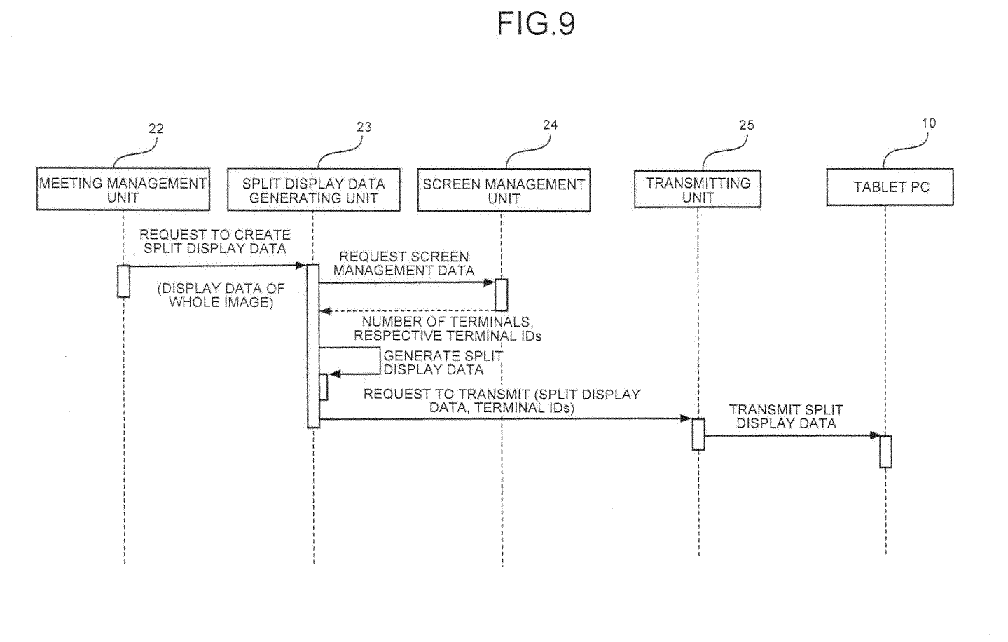

Sequential operations to output split display data performed by the meeting management unit 22, the split-display data generating unit 23, the screen management unit 24, and the transmitting unit 25 in the screen control server 2 depicted in FIG. 4 will be described with reference to the sequence diagram in FIG. 9.

The meeting management unit 22 first sends display data of a whole image concerning the meeting data to be executed to the split-display data generating unit 23, and requests the split-display data generating unit 23 to create split display data.

When the split-display data generating unit 23 receives the request, the split-display data generating unit 23 requests screen management data from the screen management unit 24. The screen management unit 24 replies to the split-display data generating unit 23 with the number of terminals and the respective terminal IDs in the screen management data 212. When the split-display data generating unit 23 obtains the screen management data, the split-display data generating unit 23 divides the display data of the whole image in accordance with the number of terminals so as to generate the split display data. The split-display data generating unit 23 then sends the respective pieces of split display data generated and the corresponding terminal IDs to the transmitting unit 25, and requests the transmitting unit 25 to transmit.

When the transmitting unit 25 receives, along with the request to transmit, the respective pieces of split display data and the corresponding terminal IDs, the transmitting unit 25 transmits the respective pieces of split display data to the corresponding tablet PCs 10 indicated by the terminal IDs.

Although not depicted in FIG. 9, each of the tablet PCs 10 receives the split display data of its own by the receiving unit 113 depicted in FIG. 4, and displays the split display data on the screen display unit 181 (the touch screen 18 depicted in FIG. 3).

When a plurality of screens are used for a single meeting, a plurality of pieces of the screen management data 212 are set up for the same meeting data 21. Thus, the screen management unit 24 transmits in sequence the screen ID for each piece of the screen management data 212, along with the number of terminals and the respective terminal IDs thereof to the split-display data generating unit 23.

Consequently, the split-display data generating unit 23 generates in sequence the split display data in accordance with the number of terminals for each screen ID, and then transmits the respective pieces of split display data and the corresponding terminal IDs thereof to the transmitting unit 25 and requests the transmitting unit 25 to transmit.

When the transmitting unit 25 receives the split display data and the corresponding terminal IDs thereof for the respective screen IDs, the transmitting unit 25 transmits the respective pieces of split display data to the corresponding tablet PCs 10 indicated by the screen ID.

The screen control server 2 also executes the above-described sequential operations, for example, when an instruction to switch display screens is received from the management terminal 3, when revision to the display data of the whole image by touch input is received from the tablet PC 10 constituting the screen 1, or when an increase or a decrease in the number of tablet PCs 10 constituting the screen 1 occurs. The screen control server 2 regenerates the split display data on each occasion, and transmits the respective pieces of re-divided split display data to the corresponding tablet PCs 10.

Consequently, each of the tablet PCs 10 displays the split display data corresponding to the layout position thereof, and the screen 1 constituted by those tablet PCs 10 displays new display data or revised display data as a whole.

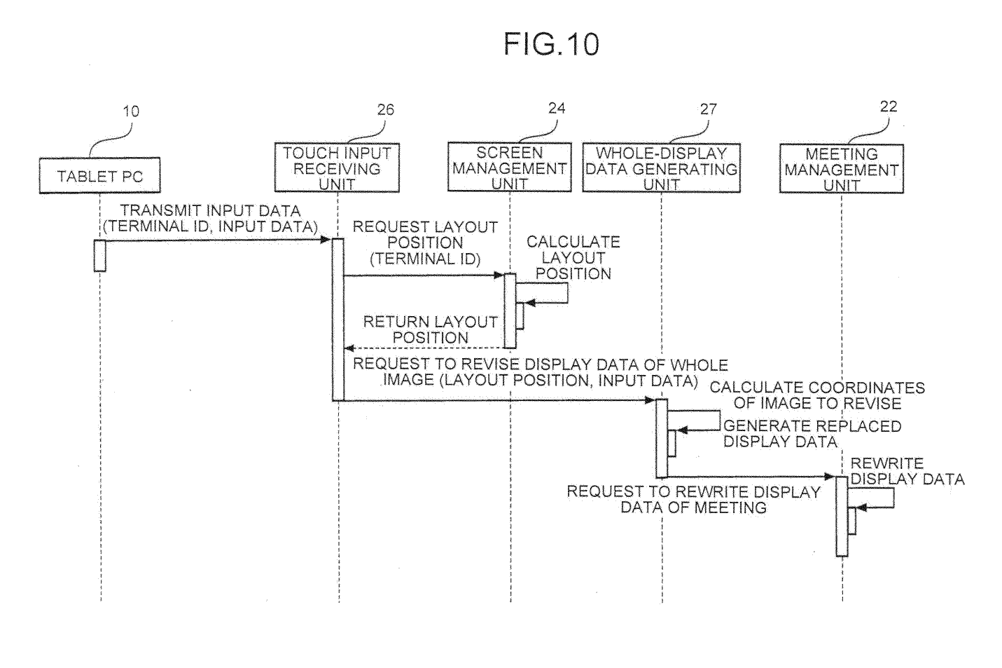

Next, sequential operations of the respective units in the screen control server 2 to edit the display data of the whole image when touch input is performed on the tablet PC 10 will be described with reference to the sequence diagram in FIG. 10.

When touch input is performed on the touch input unit 182 (the touch screen 18 depicted in FIG. 3) of the tablet PC 10, the tablet PC 10 transmits a terminal ID and input data from the touch input transmitting unit 112 to the touch input receiving unit 26 of the screen control server 2.

The touch input receiving unit 26 sends the terminal ID to the screen management unit 24, and requests the information of layout position for the terminal ID from the screen management unit 24. Consequently, the screen management unit 24 calculates the layout position of the tablet PC 10 that transmitted the input data, and then replies to the touch input receiving unit 26 with the information of the layout position. Upon obtaining the information of the layout position, the touch input receiving unit 26 sends the information of the layout position and the input data to the whole-display data generating unit 27, and requests the whole-display data generating unit 27 to revise the display data of the whole image.

The whole-display data generating unit 27 calculates coordinates of the image to be revised in the display data of the whole image from the information of layout position received, and revises the display data of the whole image to generate the display data replaced. The whole-display data generating unit 27 then sends the replaced display data to the meeting management unit 22, and requests the meeting management unit 22 to rewrite the display data of the meeting (display data of the whole image).

The meeting management unit 22 rewrites the display data of the meeting data (display data of the whole image) with the replaced display data in accordance with the rewriting request.

When the display data of the whole image is rewritten as in the foregoing, the split-display data generating unit 23 that is the generating unit divides the display data of the whole image rewritten in accordance with the number of terminals, and regenerates the respective pieces of split display data.

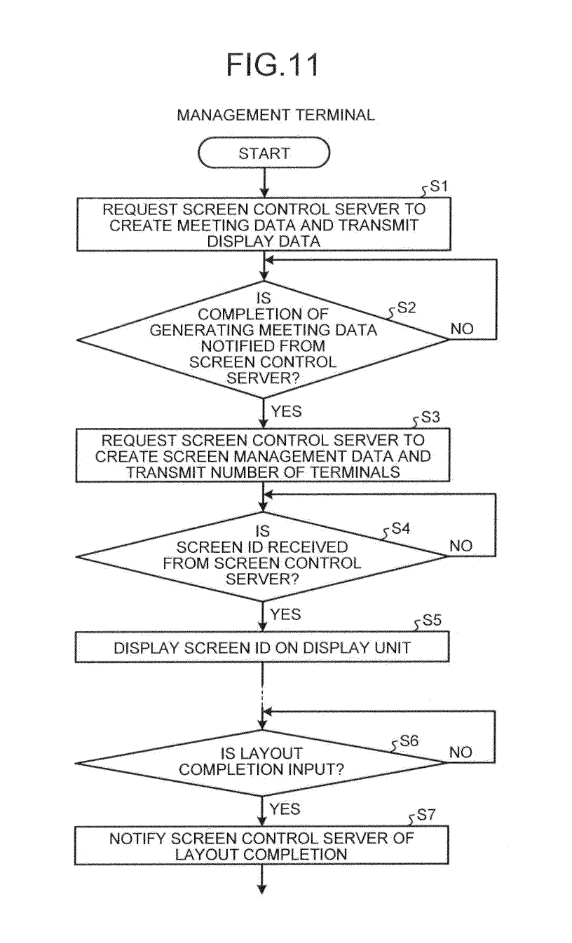

The sequence of main operations performed by the management terminal 3, the screen control server 2, and the tablet PC 10 depicted in FIG. 4 will now be described with reference to the flowcharts in FIGS. 11 to 15. In any of the flowcharts, the term Step is abbreviated as S, and likewise, the term Step is described as S in the following descriptions.

The sequence of operations performed by the management terminal 3 when starting up a meeting will first be described with reference to FIG. 11.

When the management terminal 3 starts operating, the management terminal 3 requests the screen control server 2 to create meeting data and transmits display data used for the meeting to the screen control server 2 at Step S1. The display data is prepared, for example, by being created and transferred by another PC in advance, or by reading the display data stored in a storage medium such as a USB memory.

Subsequently, the management terminal 3 waits until the completion of generating the meeting data is notified from the screen control server 2 at Step S2. The management terminal 3 advances to the process at Step S3 when notified, requesting the screen control server 2 to create screen management data and transmitting the number of terminals (the number of tablet PCs) constituting the screen. The number of terminals is input by the administrator in advance.

The management terminal 3 then waits until a screen ID that identifies the screen is received from the screen control server 2 at Step S4. When the screen ID is received, the management terminal 3 displays the screen ID on a display unit (display) at Step S5.

The management terminal 3 then waits for the layout completion to be input by the administrator at Step S6 after the administrator reads the screen ID displayed, makes the respective tablet PCs 10 constituting the screen registered to the screen control server 2, makes the respective tablet PCs 10 be placed based on the layout position information from the screen control server 2 either by himself/herself or by informing the administrators of the respective tablet PCs of the screen ID, and checks for the completion of placement.

When the management terminal 3 determines that the layout completion is input at Step S6, the management terminal 3 advances to the process at Step S7, notifying the screen control server 2 of the layout completion of the tablet PCs constituting the screen.

This series of operations corresponds to the operations of the management terminal 3 performed in the sequential operations described with reference to FIG. 6.

Subsequent to this, the management terminal 3 may perform operations as necessary, for example, to instruct the screen control server 2 to switch the display data (screens) and to notify the screen control server 2 of the end of the meeting.

A computer program to execute such a series of processes can be made as a management-terminal application program. Installing the program to a general-purpose personal computer or a general-purpose tablet PC, by downloading the program from the outside via a network or reading the program from a recording medium on which the program is recorded, allows the general-purpose personal computer or the general-purpose tablet PC to be used as a management terminal.

Installing the management-terminal application program to a personal computer used as the screen control server allows the personal computer to also serve as the management terminal.

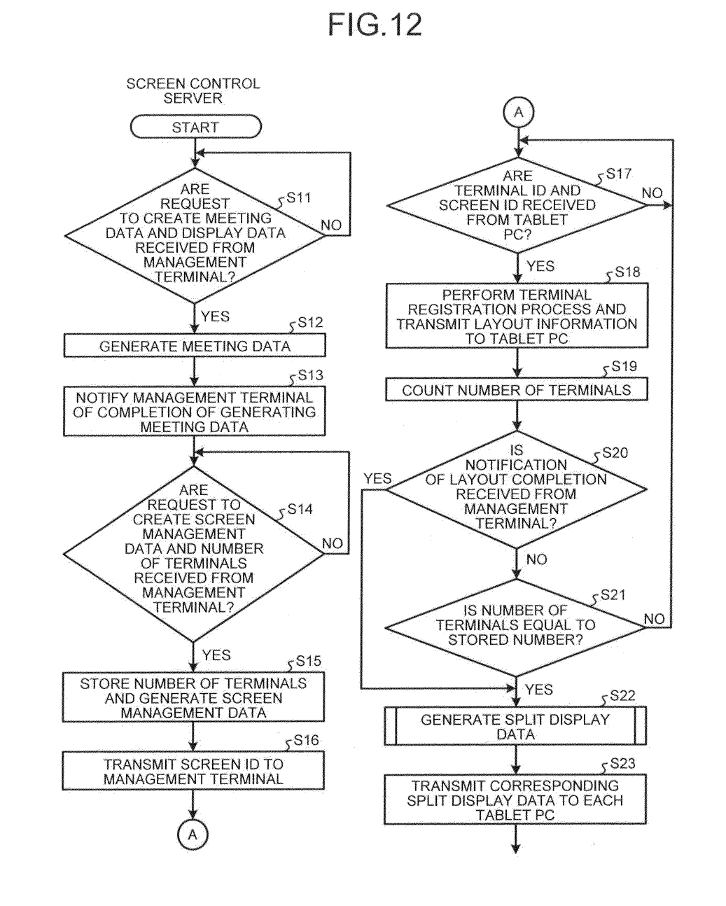

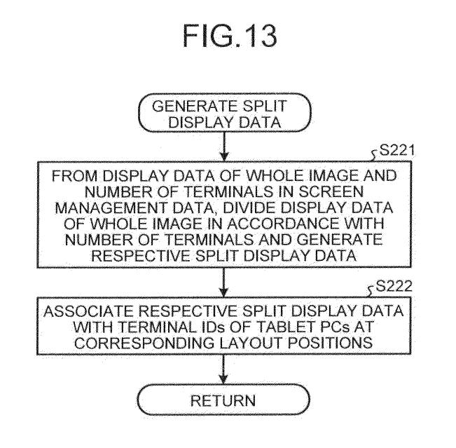

Next, the sequence of operations performed by the screen control server 2 when starting up the meeting will be described with reference to FIGS. 12 and 13.

When the screen control server 2 starts operating, the screen control server 2 waits to receive a request to create meeting data and display data from the management terminal 3 at Step S11 in FIG. 12. When the screen control server 2 receives the request and the display data, the screen control server 2 generates the meeting data at Step S12, and then notifies the management terminal 3 of the completion of generating the meeting data at Step S13.

The screen control server 2 then waits to receive a request to create screen management data and the number of terminals from the management terminal 3 at Step S14. When the screen control server 2 receives the request and the number of terminals, the screen control server 2 stores the number of terminals received and generates the screen management data at Step S15, and then transmits a screen ID to identify the screen to the management terminal 3 at Step S16.

Subsequently, the screen control server 2 waits to receive the information of the terminal ID and the screen ID from the tablet PC 10 at Step S17. When the screen control server 2 receives the information of the terminal ID and the screen ID, the screen control server 2 performs a terminal registration process in which the layout position of the terminal identified by the terminal ID is determined in the order of registration, and as illustrated in FIG. 4, the terminal ID and the layout position thereof are stored in association with each other in the screen management data 212 corresponding to the screen ID, and then transmits the layout information to the tablet PC 10 at Step S18.

The screen control server 2 then counts (adds one to a count value) the number of terminals on which the terminal registration process is performed at Step S19, and determines whether the notice of layout completion is received from the management terminal 3 at Step S20. When the notice is received, the screen control server 2 advances to the process at Step S22. When the notice is not received, the screen control server 2 advances to the process at Step S21, determining whether the number of terminals counted (the count value) is equal to the stored number (number of terminals stored).

As a result, when the number of terminals counted is equal to the stored number, the screen control server 2 advances to the process at Step S22. When the numbers are not equal, the screen control server 2 returns to the process at Step S17 and waits to receive the information of the terminal ID and the screen ID from a subsequent tablet PC 10. The screen control server 2 then repeats the process from Step S17 to Step S21 to perform the registration process and to notify the tablet PC 10 of the layout position for all of the tablet PCs 10 constituting the screen until either a notice of layout completion is received at Step S20 or the number of terminals is equal to the stored number at Step S21.

When the screen control server 2 determines that the notice of layout completion is received at Step S20 or that the number of terminals counted is equal to the stored number at Step S21, as this means that the registration process for all of the tablet PCs 10 is completed, the screen control server 2 then generates split display data at Step S22, and transmits the split display data corresponding to the respective tablet PCs 10 at Step 323.

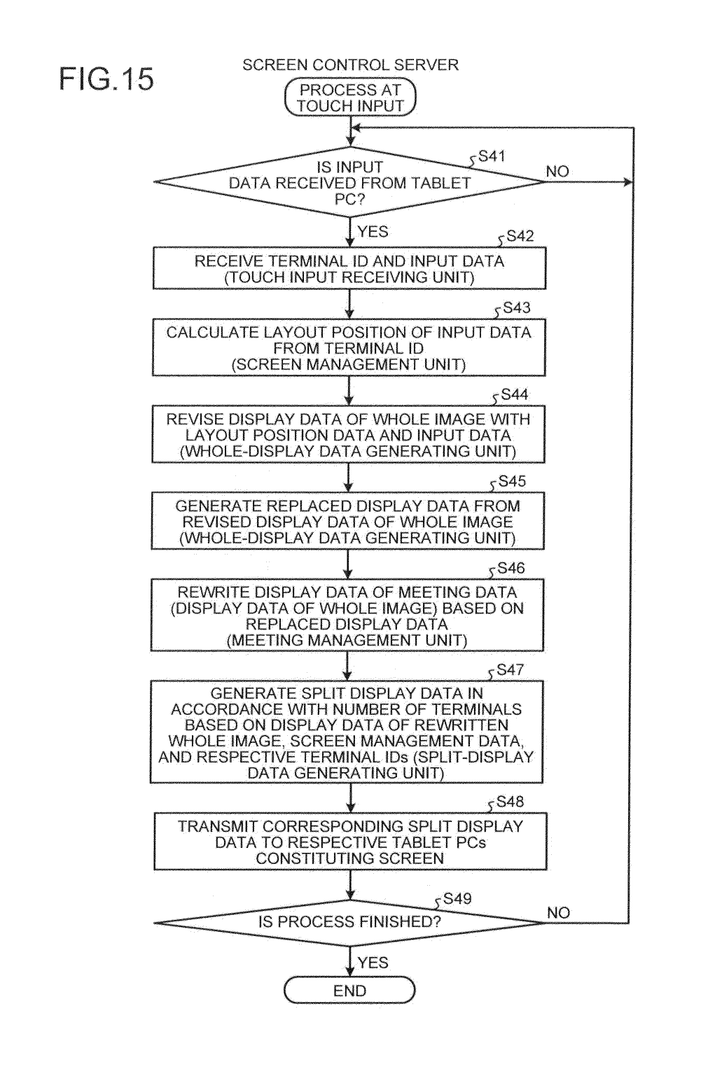

This series of operations corresponds to the operations of the screen control server 2 performed in the sequential operations described with reference to FIG. 6. Subsequently, the screen control server 2 performs, for example, the process at the time of touch input which will be described with reference to FIG. 15.

In a subroutine of split-display data generation at Step S22, as illustrated in FIG. 13, the screen control server 2 divides, based on the display data of the whole image and the number of terminals in the screen management data, the display data of the whole image in accordance with the number of terminals constituting the screen, and generates split display data for split display on the respective tablet PCs 10 at Step S221. The screen control server 2 then makes association between the pieces of split display data and the terminal IDs of the respective display positions (i.e., layout positions) at Step S222.

A computer program to execute such a series of processes or to further execute the process at the time of touch input described with reference to FIG. 15 can be made as a screen-control server application program. Installing the program to a general-purpose personal computer and such, by downloading the program from the outside via a network or reading the program from a recording medium on which the program is recorded, allows the general-purpose personal computer to be used as a screen control server.

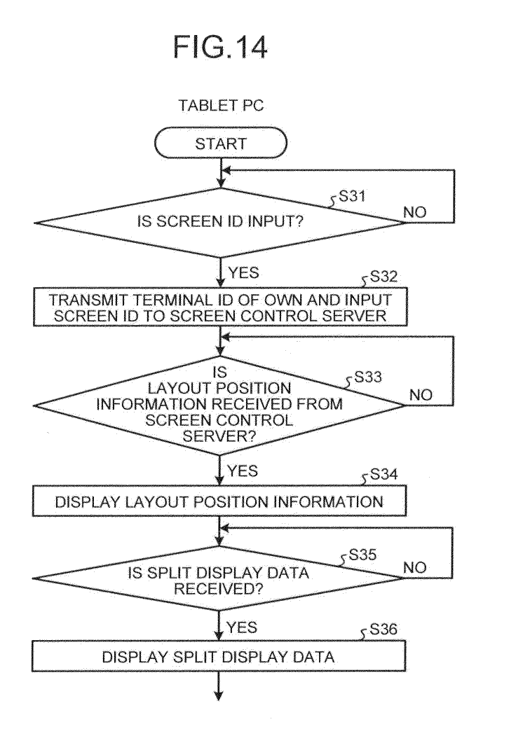

The sequence of operations performed by the tablet PC 10 when starting up the meeting will be described with reference to FIG. 14.

When the tablet PC 10 starts operating, the tablet PC 10 waits for a screen ID to be input at Step S31. This means to wait for the administrator to input the screen ID to the tablet PC 10 to make the tablet PC 10 registered as a terminal constituting the screen, as the management terminal 3 displays the screen ID when the management terminal 3 is notified of the screen ID from the screen control server 2, and the administrator subsequently looks at the display and finds out the screen ID of the screen to be made.

When the screen ID is input, the tablet PC 10 advances to the process at Step S32 from Step S31, adding the screen ID received to the own terminal ID preset and transmitting the information of the terminal ID and the screen ID to the screen control server 2.

The tablet PC 10 then waits to receive layout position information from the screen control server 2 at Step S33. When the tablet PC 10 receives the layout position information, the tablet PC 10 displays the layout position information, as illustrated in FIG. 7 or 8, on the screen display unit 181 (the touch screen 18 depicted in FIG. 3) at Step S34. Consequently, the administrator is able to place the tablet PC 10 to a given layout position constituting the screen.

The tablet PC 10 then waits to receive split display data from the screen control server 2 at Step S35. When the tablet PC 10 receives the split display data, the tablet PC 10 displays the split display data on the screen display unit 181 (the touch screen 18 depicted in FIG. 3) at Step S36.

That the respective tablet PCs 10 constituting the screen 1 depicted in FIG. 1 display the corresponding pieces of split display data allows the screen 1 as a whole to display the display data of a single image.

This series of operations corresponds to the operations of the tablet PC 10 performed in the sequential operations described with reference to FIG. 6.

A computer program to execute such a series of processes can be made as a computer program of the screen control application 110 depicted in FIG. 4. Installing the program to a general-purpose tablet PC, by downloading the program from the outside via a network or reading the program from a recording medium on which the program is recorded, allows the general-purpose tablet PC to be used as a tablet PC constituting the screen.

With reference to FIG. 15, a sequence of operations performed by the screen control server 2 at the time of touch input will be described.

The screen control server 2 first waits to receive input data from the tablet PC 10 at Step S41. When the input data is received, the touch-input receiving unit 26 receives and holds a terminal ID and the input data at Step S42.

The screen management unit 24 then calculates a layout position of the input data from the terminal ID at Step S43. The whole-display data generating unit 27 then revises the display data of the whole image with the data of layout position and the input data at Step S44. The whole-display data generating unit 27 further generates the replaced display data from the revised display data of the whole image at Step S45. The meeting management unit 22 then rewrites the display data of the meeting data (display data of the whole image) with the replaced display data at Step S46.

Subsequently, the split-display data generating unit 23 generates the split display data in accordance with the number of terminals based on the display data of the whole image rewritten, the screen management data, and the respective terminal IDs at Step S47.

The transmitting unit 25 then transmits the respective pieces of split display data to the corresponding tablet PCs 10 constituting the screen at Step S48.

The screen control server 2 then determines whether the touch input process is finished at Step S49. When the process is not finished, the screen control server 2 returns to the process at Step S41 and waits to receive input data from the tablet PC 10, and when the input data is received, the screen control server 2 then repeats the above-described operations. When the process is finished at Step S49, the screen control server 2 ends the process.

This series of operations corresponds to the sequential operations of the screen control server 2 described with reference to FIGS. 9 and 10 performed in series.

As for a computer readable recording medium on which the respective application programs in the foregoing are recorded, a variety of recording media such as flexible disks, CD-ROMs, MOs, memory cards, and USB memories can be used.

The screen control system thus configured in accordance with the invention uses a plurality of general-purpose information processing terminals such as tablet PCs to configure a single large screen, thereby allowing the screen control system to be readily used anywhere in a similar way to a conventional electronic blackboard system and to be set up and moved easily.

Furthermore, the invention is not restricted to the above-described embodiment, and the configuration can be appended, modified, or omitted appropriately within the scope as defined in claims.

For example, the functions of the screen control server 2 may be provided in any of the tablet PCs 10. In this case, the tablet PC 10 that has the functions of the screen control server 2 may naturally participate in displaying the whole image by a plurality of tablet PCs in collaboration as illustrated in FIGS. 7 and 8. When the transmission destination of split display data by the transmitting unit 25 is itself, the transmission only needs to be performed by interprocess communication between the process to achieve the functions of the screen control server 2 and the process to achieve the functions of the tablet PC 10, in particular, the screen control application 110.

Moreover, the functions of the screen control server 2 may be distributed over a plurality of devices, and the devices may collaborate to function as the screen control server 2. In this case, one or more of the devices may be the tablet PCs 10.

The configurations or functions in the above-described embodiment and modification can be combined appropriately as long as being mutually consistent.

The screen control system in accordance with the embodiment uses a plurality of general-purpose information processing terminals to configure a screen of any size, and thus the screen control system can be readily used as compared with conventional electronic blackboard systems and can be set up or moved easily.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A screen control system comprising:
a plurality of information processing terminals; and
a screen control device that makes the information processing terminals function as a screen display device to display a single screen, wherein
the screen control device includes
a holding unit that holds display data to display using the information processing terminals, number of terminals indicative of number of information processing terminals constituting the screen, terminal identification information that identifies each of the information processing terminals, and information indicative of a layout position of each of the information processing terminals in the screen;
a generating unit that generates split display data obtained by dividing the display data in accordance with the number of terminals; and
a split-display data transmitting unit that transmits each piece of the split display data corresponding to corresponding one of the layout positions to corresponding one of the information processing terminals, and
the information processing terminals each include
a transmitting unit that transmits the terminal identification information of the corresponding information processing terminal to the screen control device;
a receiving unit that receives the split display data transmitted from the screen control device; and
a display unit that displays the split display data received by the receiving unit.

2. The screen control system according to claim 1, wherein
the transmitting unit of at least one of the information processing terminals further has a function of transmitting the display data, the number of terminals, and a notification indicating that placement of all of the information processing terminals constituting the screen is completed to the screen control device, and
the generating unit of the screen control device generates the split display data after the notification indicating that the placement of the information processing terminals is completed is received from the information processing terminal.

3. The screen control system according to claim 1, wherein
the holding unit of the screen control device determines, when terminal identification information is received from an information processing terminal, a layout position of the information processing terminal having the terminal identification information in the screen and generates at least one piece of screen management data in which the terminal identification information and information indicative of the layout position are registered in association with each other, and
the transmitting unit of each of the information processing terminals makes a request to register the terminal identification information to the screen management data when transmitting the terminal identification information.

4. The screen control system according to claim 3, wherein
the transmitting unit transmits, when the holding unit determines the layout position, information indicative of the layout position to the information processing terminal having the terminal identification information corresponding to the layout position, and
the display unit displays information indicative of the layout position transmitted to the corresponding information processing terminal from the screen control device and received by the receiving unit.

5. The screen control system according to claim 1, wherein
the information processing terminals each include a touch input unit integrally provided with a screen display unit in a panel form, and a touch-input transmitting unit that transmits touch input data from the touch input unit to the screen control device,
the screen control device includes a touch-input receiving unit, and a rewriting unit that rewrites the display data based on the touch input data from any of the information processing terminals received by the touch-input receiving unit, and
the generating unit generates the split display data by dividing the rewritten display data in accordance with the number of terminals when the display data is rewritten by the rewriting unit.

6. The screen control system according to claim 1, wherein the number of information processing terminals constituting the screen is n² (n is an integer of two or greater).

7. A screen control device that makes a plurality of information processing terminals function as a screen display device to display a single screen, the screen control device comprising:
a holding unit that holds display data to display using the information processing terminals, number of terminals indicative of number of information processing terminals constituting the screen, terminal identification information that identifies each of the information processing terminals, and information indicative of a layout position of each of the information processing terminals in the screen;
a generating unit that generates split display data obtained by dividing the display data in accordance with the number of terminals; and
a split-display data transmitting unit that transmits each piece of the split display data corresponding to corresponding one of the layout positions to corresponding one of the information processing terminals.

8. The screen control device according to claim 7, wherein the holding unit includes a unit that determines, when terminal identification information is received from an information processing terminal, a layout position of the information processing terminal having the terminal identification information in the screen and generates at least one piece of screen management data in which the terminal identification information and information indicative of the layout position are registered in association with each other.

9. The screen control device according to claim 8, wherein the split-display data transmitting unit further has a function of transmitting, when the holding unit determines the layout position, the information indicative of the layout position to the information processing terminal having the terminal identification information corresponding to the layout position.

10. The screen control device according to claim 7, further comprising:
a receiving unit that receives touch input data when transmitted from any of the information processing terminals, and
a rewriting unit that rewrites the display data based on the touch input data received by the receiving unit, wherein
the generating unit divides the rewritten display data in accordance with the number of terminals to generate the split display data when the display data is rewritten by the rewriting unit.

11. An information processing terminal that is capable of performing communication with a screen control device and serves as a screen display device that displays a single screen together with one or more information processing terminals, the information processing terminal comprising:
a transmitting unit that transmits own terminal identification information to the screen control device;
a receiving unit that receives split display data transmitted from the screen control device; and
a display unit that displays the split display data received by the receiving unit, wherein
the split display data is display data generated by dividing display data held by the screen control device in accordance with number of the information processing terminals.

12. The information processing terminal according to claim 11, further comprising a unit that receives information indicative of a layout position of the information processing terminal in the screen from the screen control device and makes the display unit display the information.

13. The information processing terminal according to claim 11, further comprising:
a touch input unit integrally provided with a screen display unit in a panel form; and
a touch-input transmitting unit that transmits touch input data from the touch input unit to the screen control device.

14. The information processing terminal according to claim 11, further comprising:
a unit that transmits display data to display using a plurality of information processing terminals to the screen control device;
a unit that transmits number of terminals indicative of number of the information processing terminals constituting the screen to the screen control device; and
a unit that transmits a notification indicating that placement of all of the information processing terminals constituting the screen is completed to the screen control device.
